(19) United States
(12) Patent Application Publication
(10) Pub. No.: US 2025/0369568 A1
(43) Pub. Date: Dec. 4, 2025

(54) COMPONENT FOR HOME APPLIANCES HAVING A THREE-DIMENSIONAL SHAPE WITH DECORATIVE PART

(71) Applicant: LG ELECTRONICS INC., Seoul (KR)

(72) Inventors: Sunwoo KIM, Seoul (KR); Youngdae YOU, Seoul (KR); Yeonseo NAM, Seoul (KR); Seok Jae JEONG, Seoul (KR)

(21) Appl. No.: 19/223,166

(22) Filed: May 30, 2025

(30) Foreign Application Priority Data
May 30, 2024 (KR) 10-2024-0070732

(51) Int. Cl. F16S 5/00

(52) U.S. Cl. CPC F16S 5/00

(57) ABSTRACT

The present invention relates to a component for home appliances to which a metallic texture is imparted by forming a decorative part only on a partial region thereof having a bent portion, and the component for home appliances according to the present invention has a three-dimensional shape, and includes a decorative part formation region in which a decorative part has been formed and which exists on at least a portion of a surface of the component, and a cross section of the decorative part formation region includes a bent portion in which a curvature varying section exists.

### CROSS-REFERENCE TO RELATED APPLICATION

This application claims priority to and the benefit of Korean Patent Application No. 10-2024-0070732, filed on May 30, 2024, the disclosure of which is incorporated herein by reference in its entirety.

### BACKGROUND

### Technical Field

The present invention relates to a component for home appliances having a three-dimensional shape with a decorative part, and more specifically, to a component for home appliances to which a metallic texture is imparted by forming a decorative part only on a partial region thereof having a bent portion.

### Description of Related Art

There have been known techniques for forming a metallic texture decorative part on the surfaces of components applied to home appliances such as washing machines, refrigerators, and dryers.

A wet plating method has been known as a method for forming a decorative part capable of imparting a metallic texture or pattern to the surface of the component. Through the wet plating method, the surface of a component can be plated with the relative simplicity by immersing the component in a plating bath. Besides, the decorative part formed by the wet plating method has the advantage of high hardness. However, it is impossible to form a edible area only on a partial region of the component with the use of the wet plating method described above. Additionally, since the wet plating method consumes a large amount of materials, it causes the increase in the unit price of the component.

Next, a dry coating method has been known as a method for forming a decorative part capable of imparting a metallic texture or pattern to the surface of the component. The dry coating method may include a step of transferring a decorative film to form a decorative part with a metallic texture on the surface of the component. Alternatively, the dry coating method may include a step of applying a decorative paste to form a decorative part with a metallic texture on the surface of the component. However, the decorative part formed by the conventional dry coating method fails to be coated smoothly on a bent surface. Additionally, the decorative part formed by the conventional dry coating method cannot avoid the occurrence of an overlapping portion formed by a plurality of decorative portions on the surface of a geometrically complex structure.

Accordingly, there is a growing desire for a novel component for home appliances in which a decorative part is formed only on a partial region despite constraints due to a complex shape.

### SUMMARY

It is an object of the present invention to provide a component for home appliances in which a decorative part has been formed on a portion of the component having a bent three-dimensional shape, whose surface could not be surface-treated using conventional methods.

Also, it is an object of the present invention to provide a component for home appliances in which a decorative part has been formed only on a partial region which is visible in a home appliance, while reducing the costs.

Also, it is an object of the present invention to provide a component for home appliances having a high degree of design freedom even in a geometrically complex structure thereof.

The purposes of the present invention are not limited to the purposes mentioned above, and other purposes and advantages of the present invention which are not mentioned can be appreciated from the following description, and will be more clearly appreciated by the embodiments of the present invention. Furthermore, it is readily understood that the objects and advantages of the present invention can be achieved by the means set forth in the claims and combinations thereof.

A component for home appliances according to the present invention for accomplishing the above-described technical objects has a decorative part formation region in which a decorative part is formed, and which exists in a partial region having a bent portion in which a curvature varying section exists.

Specifically, the component for home appliances according to the present invention has a three-dimensional shape, the decorative part formation region to which the decorative part has been transferred exists on at least a portion of a surface of the component, and a cross section of the decorative part formation region includes a bent portion in which a curvature varying section exists. Thereby, the present invention can provide a component for home appliances in which a decorative part has been formed on a portion of the component having a bent three-dimensional shape, whose surface could not be surface-treated using conventional methods.

Here, the curvature varying section may be an overlapping section of lines with different curvatures or an inflection point where lines with different curvatures meet with each other.

Preferably, in the decorative part formation region, the decorative part may be formed continuously. Additionally, in the decorative part formation region, the decorative part may be formed continuously, and the number of steps generated by the overlapping of the decorative part may be one or less.

The component for home appliances according to one embodiment of the present invention may include an edge having an asymmetrical shape, a cross section of the edge may include a bent portion in which a curvature varying section exists, and on at least a portion of a surface of the edge, the decorative part formation region may exist.

Additionally, the component for home appliances according to one embodiment of the present invention may have a cylindrical shape, a chamfer may be formed at a corner portion where the upper surface and the outer circumferential surface thereof meet with each other, and on at least a portion of a surface of the chamfer, the decorative part formation region may exist.

Additionally, the component for home appliances according to one embodiment of the present invention may have a fan-shaped surface, and on at least a portion of the fan-shaped surface, the decorative part formation region may exist.

Additionally, the component for home appliances according to one embodiment of the present invention may have a panel shape, and on at least a portion of an outer circumferential surface of the component, the decorative part formation region may exist.

Additionally, the component for home appliances according to one embodiment of the present invention may have a basket shape, and on at least a portion of an outer circumferential surface of the component, the decorative part formation region may exist.

### Advantageous Effects

According to the present invention, it is possible to provide a component for home appliances in which a decorative part has been formed on a portion of the component having a bent three-dimensional shape, whose surface could not be surface-treated using conventional methods.

Also, it is possible to provide a component for home appliances in which a decorative part has been formed only on a partial region which is visible, with the reduced costs.

Also, the present invention can provide a component for home appliances having a high degree of design freedom even in a geometrically complex structure thereof.

In addition to the effects described above, specific effects of the present invention will be described below together with specific matters for practicing the invention.

### BRIEF DESCRIPTION OF DRAWINGS

FIG. 1 is a perspective view illustrating a component for home appliances according to one embodiment of the present invention.

FIG. 2 shows a cross-sectional view taken along line 2-2′ in FIG. 1.

FIG. 3 is a front view showing a washing machine to which components of the present invention are applied.

FIG. 4 is a front view showing the door component for a washing machine according to one embodiment of the present invention.

FIG. 5 is a cross-sectional view taken along line 5-5′ in FIG. 4.

FIG. 6 is a cross-sectional view taken along line 6-6′ in FIG. 4.

FIG. 7 is a view schematically showing an apparatus for forming a decorative part of a door component for a washing machine according to one embodiment of the present invention.

FIG. 8 is a view schematically showing an apparatus for forming a decorative part of a door component for a washing machine according to one embodiment of the present invention.

FIG. 9 is a plan view illustrating the knob component according to one embodiment of the present invention.

FIG. 10 represents a portion of a cross-sectional view taken along line 10-10′ in FIG. 9.

FIG. 11 is a schematic view of an apparatus for forming a decorative part of a knob component according to one embodiment of the present invention.

FIG. 12 is a plan view illustrating a handle component according to one embodiment of the present invention.

FIG. 13 illustrates a portion of a cross-sectional view taken along line 13-13′ in FIG. 12.

FIG. 14 is a schematic view of an apparatus for forming a decorative part of a handle component according to one embodiment of the present invention.

FIG. 15 is a plan view illustrating a panel-shaped component according to one embodiment of the present invention.

FIG. 16 is a perspective view illustrating a portion of the panel-shaped component according to one embodiment of the present invention.

FIG. 17 is a perspective view illustrating a basket-shaped component according to one embodiment of the present invention.

FIG. 18 is a perspective view illustrating a portion of the basket-shaped component according to one embodiment of the present invention.

FIG. 19 is a schematic view of an apparatus for forming a decorative part of a basket-shaped component according to one embodiment of the present invention.

FIG. 20 is a front view showing a refrigerator to which components of the present invention are applied.

FIG. 21 is a front view showing a handle component for a refrigerator according to one embodiment of the present invention.

FIG. 22 is a cross-sectional view taken along line 22-22′ in FIG. 21.

FIG. 23 is a front view illustrating a dispenser component for a refrigerator according to one embodiment of the present invention.

FIG. 24 is a cross-sectional view taken along line 24-24′ in FIG. 23.

FIG. 25 is a front view showing a handle bar component for a refrigerator according to one embodiment of the present invention.

FIG. 26 is a cross-sectional view taken along line 26-26′ in FIG. 25.

### DETAILED DESCRIPTIONS

The purposes, features and advantages described above will be described in detail below with reference to the accompanying drawings, so that a person having ordinary knowledge in the technical field to which the present invention pertains can easily practice the technical idea of the present invention. In describing the present invention, if it is determined that a detailed description of a known technology related to the present invention may unnecessarily obscure the gist of the present invention, the detailed description thereof will be omitted. Hereinafter, preferred embodiments of the present invention will be described in detail with reference to the accompanying drawings. In the drawings, like reference symbols are used to refer to like or similar components.

As used herein, singular expressions include plural expressions unless the context clearly dictates otherwise. Herein, the terms “be comprised of” or “comprise” should not be construed to necessarily include all of the various components or various steps described in the specification, and should be construed to mean that some of the components or some of the steps may not be included, or that additional components or steps may be included.

Hereinafter, components for home appliances according to the present invention will be described in detail with reference to the drawings.

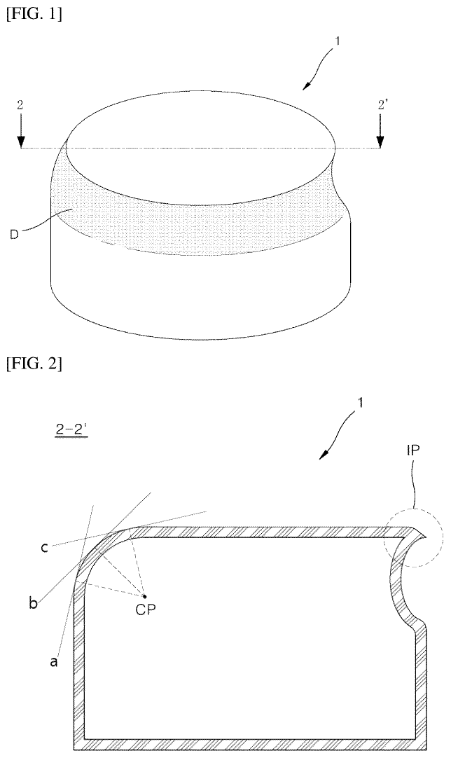

FIG. 1 is a perspective view illustrating a component 1 for a home appliance according to one embodiment of the present invention. Referring to FIG. 1, the component 1 for a home appliance according to the present invention has a three-dimensional shape, and on at least a portion of its surface, there exists a decorative part formation region D in which a decorative part has been formed, and the cross section of the decorative part formation region D includes a bent portion in which a curvature varying section exists.

Through the wet plating process, the decorative part cannot be formed in the above-described decorative part formation region D. Additionally, in the case where the decorative part is formed through the dry coating method, it fails to be coated smoothly on the surface of a geometrically complex structure, such as the bent portion in which the curvature varying section exists. Forming the decorative part on the surface of the geometrically complex structure through the dry coating method has difficulty in avoiding the occurrence of the overlapping portion formed by a plurality of decorative portions. However, the component 1 for home appliances according to the present invention has the decorative part formation region D formed on a surface of a geometrically complex structure, such as a bent portion in which a curvature varying section exists.

Referring to FIG. 2, the bent portion in which the curvature varying section exists will be described in more detail.

FIG. 2 shows a cross-sectional view taken along line 2-2′ in FIG. 1.

First, referring to the left side of the cross-sectional view illustrated in FIG. 2, the decorative part formation region D may include a curvature varying section, which may include an overlapping section of lines with different curvatures. Here, the overlapping section of lines with different curvatures may mean a section made of a round-shaped line formed by the curves with different curvatures continuously overlapping with each other. While assuming a line segment extending from a center point CP located in the left side inside the cross section of the component 1 to any point on the cross section of the decorative part formation region as the radius of a circle with the center point as the center of the circle, tangent lines a, b, c may be drawn whose slopes are all different from each other. Thereby, the decorative part formation region D of the component 1 includes an overlapping section of lines with different curvatures.

Additionally, referring to the right side of the cross-sectional view illustrated in FIG. 2, the decorative part formation region D may include a curvature varying section, which may include an inflection point IP where lines with different curvatures meet withe each other. With reference to the right cross section of the component 1, it can be ascertained that the inflection point IP is generated by two lines with different curvatures meeting with each other. Consequently, the decorative part formation region D of the component 1 includes the inflection point IP where lines with different curvatures meet.

In the decorative part formation region, it is preferable that the decorative part is formed continuously. The conventional decorative part could not be formed continuously on the bent portion of a complex structure. However, the component of the present invention includes the decorative part continuously formed even on the bent portion of a complex structure.

Additionally, in the decorative part formation region, the decorative part may be formed continuously, and the number of steps generated by the overlapping of the decorative part may be one or less.

Preferably, the decorative part may be formed by subjecting a decorative film to the transfer procedure by a hot stamping process.

Herein, the hot stamping process refers to a process of transferring a decorative substance, for example, a decorative pattern on the decorative film, to a transfer target, such as the surface of the component for home appliances, by a thermal pressing method. The temperature, pressure and time conditions under which the hot stamping process is performed may vary depending on the materials of the decorative film and the transfer target. For example, in the present invention, the hot stamping process may be performed under the conditions of a temperature of 100 to 250° C., a pressure of 1 to 30 kg/cm2, and a time of 1 to 60 seconds.

Additionally, the decorative film may employ a known decorative film which can impart a metallic texture or pattern to the surface of a component for home appliances. Besides, the decorative film may employ a decorative film having a plurality of layers thereon as needed.

Hereinafter, various embodiments of the component for home appliances according to the present invention will be discussed in detail.

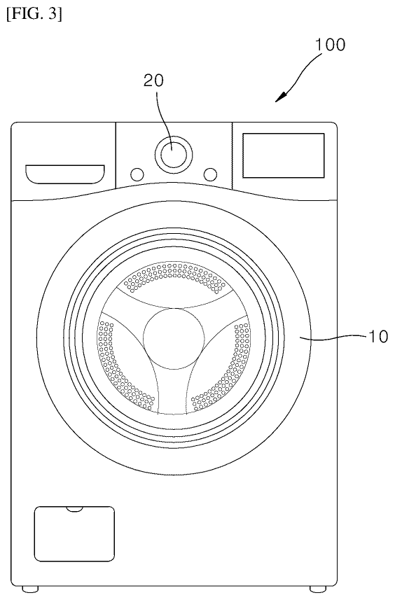

FIG. 3 is a front view showing a washing machine to which components of the present invention are applied. Referring to FIG. 3, the washing machine 100 includes a door component 10 and a knob component 20, and both the door component 10 and the knob component 20 have the decorative part formation region D existing thereon.

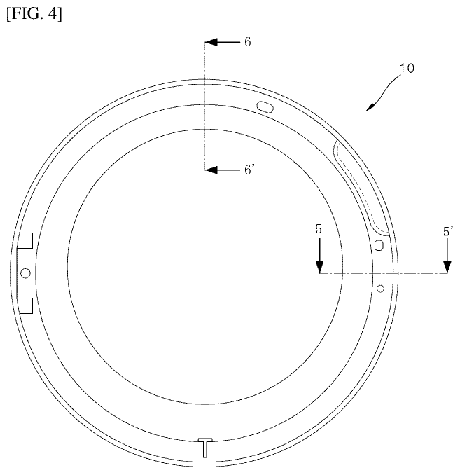

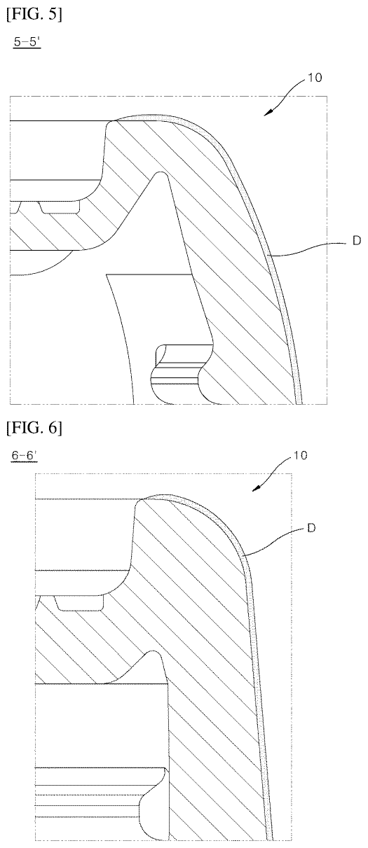

FIG. 4 is a front view showing the door component 10 for a washing machine according to one embodiment of the present invention; FIG. 5 is a cross-sectional view taken along line 5-5′ in FIG. 4; and FIG. 6 is a cross-sectional view taken along line 6-6′ in FIG. 4.

Referring to FIG. 4, the component 10 according to one embodiment of the present invention may include an edge having an asymmetrical shape, the cross section of the edge may include the bent portion in which the curvature varying section exists, and the decorative part formation region D may exist on at least a portion of the surface of the edge.

Referring to FIGS. 5 and 6, the edge of the component 10 has an asymmetrical shape whose curvatures at 5-5′ and 6-6′ are different from each other. Additionally, the decorative part formation region D may exist on at least a portion of the surface of the edge. Preferably, the decorative part formation region D may be formed by subjecting the decorative film to the transfer procedure by the hot stamping process.

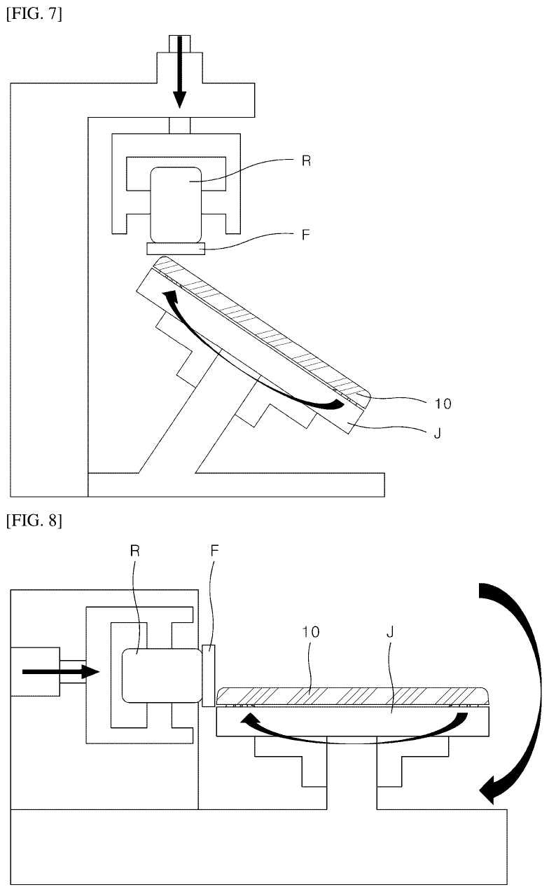

According to one example of the present invention, the decorative part may be formed on the surface of the component 10 using a hot stamping apparatus as shown in FIG. 7 or 8.

FIGS. 7 and 8 respectively show a schematic view of the hot stamping apparatus forming the decorative part on the edge of the component 10.

First, the apparatus illustrated in FIG. 7 will be described. The apparatus of FIG. 7 may be used to form the decorative part on the upper surface of the edge of the component 10. Referring to FIG. 7, the component 10 is loaded onto a jig J, and the jig J is rotated. At this time, a decorative film F may be subjected to the transfer procedure to the upper surface of the edge of the component 10 by a roller R.

Next, the apparatus illustrated in FIG. 8 will be described. The apparatus of FIG. 8 may be used to form the decorative part on the edge side surface of the component. Referring to FIG. 8, the component 10 is loaded onto the jig J, and the jig J is rotated. In this regard, the jig J may be tilted at a preset angle corresponding to the asymmetrical edge shape of the component 10 while being rotated. At this time, the decorative film F may be subjected to the transfer procedure to the side surface of the edge of the component 10 by the roller R.

By using the above-described apparatus, the decorative part can be formed on the asymmetrical edge of the component 10 of the present invention.

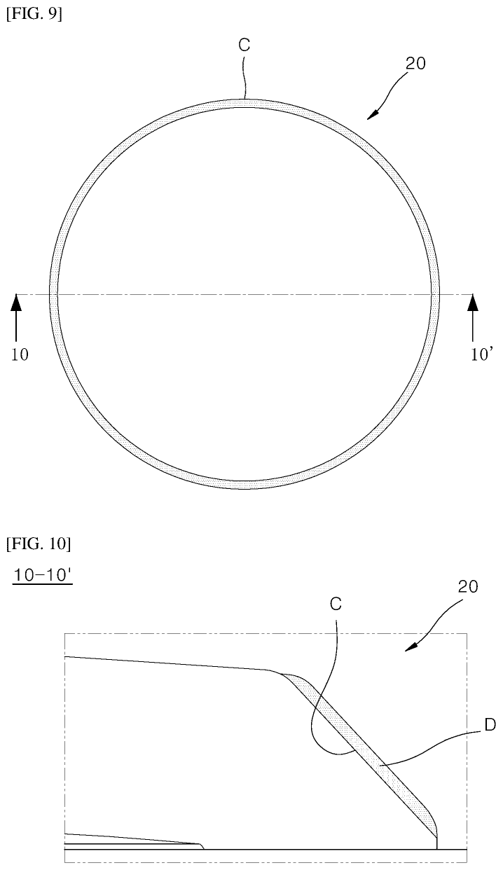

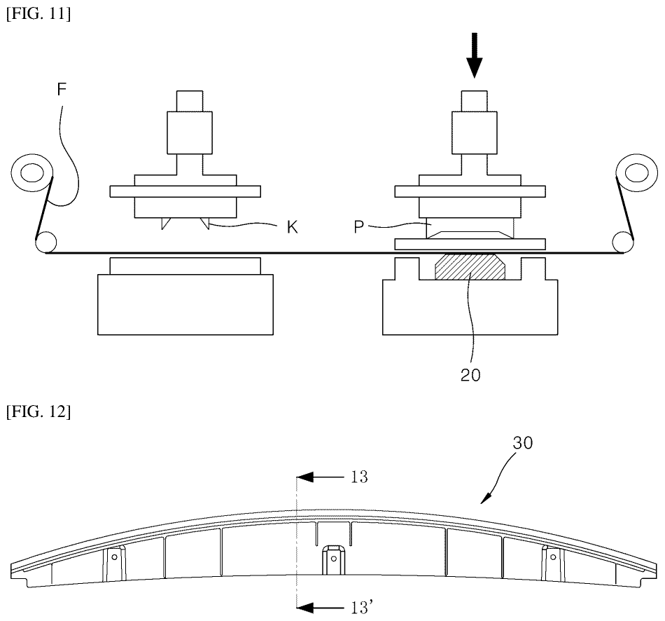

Next, FIG. 9 is a plan view illustrating the knob component 20 according to one embodiment of the present invention, and FIG. 10 represents a cross-sectional view taken along line 10-10′ in FIG. 9.

Referring to FIG. 9, the component 20 according to one embodiment of the present invention may have a cylindrical shape, and a chamfer C may be formed at a corner portion where the upper surface and the outer circumferential surface thereof meet with each other. In this regard, the decorative part formation region D may exist on at least a portion of the surface of the chamfer C.

Referring to FIG. 10, the decorative part formation region D may exist in the chamfer C of the component 20. Preferably, the decorative part formation region D may be formed by subjecting the decorative film to the transfer procedure by the hot stamping process.

According to one example of the present invention, the decorative part may be formed on the surface of the component 20 using a hot stamping apparatus as shown in FIG. 11.

FIG. 11 shows a schematic view of the hot stamping apparatus forming the decorative part on the chamfer of the component 20.

The apparatus illustrated in FIG. 11 will be described. First, using an equipment shown in the left side in FIG. 11, the decorative film F is trimmed with a trimming knife K so as to fit the size of the chamfer C. After that, using an equipment shown in the right side, the decorative film F trimmed to fit the size of the chamfer C is positioned on the top of the component 20. Thereafter, the trimmed decorative film K is subjected to the transfer procedure directly to the chamfer C of the component using a pad P.

Using the above-described apparatus, the decorative part can be formed on the chamfer C of the component 20 of the present invention. The decorative part formation region D of the component 20 can be formed continuously. Thereby, the decorative part formation region D of the component 20 does not have a joint portion where a plurality of decorative parts are brought into contact to each other.

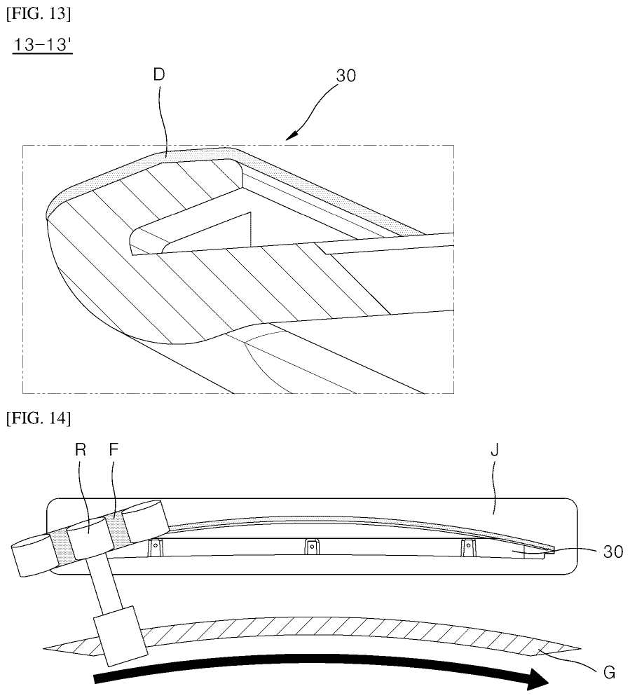

Next, FIG. 12 is a plan view illustrating a handle component 30 according to one embodiment of the present invention, and FIG. 13 illustrates a portion of a cross-sectional view taken along line 13-13′ in FIG. 12.

Referring to FIG. 12, the component 30 according to one embodiment of the present invention has a fan-shaped surface, and the decorative part formation region D may exist on at least a portion of the fan-shaped surface.

Referring to FIGS. 12 and 13, the cross section of the fan-shaped surface of the component 30 may have the bent portion. Additionally, the decorative part formation region D may exist on at least a portion of the fan-shaped surface. Preferably, the decorative part formation region D may be formed by subjecting the decorative film to the transfer procedure by the hot stamping process.

According to one example of the present invention, the decorative part may be formed on the surface of the component 30 using a hot stamping apparatus as shown in FIG. 14.

FIG. 14 shows a schematic view of the hot stamping apparatus forming the decorative part on the fan-shaped surface of the component 30.

The apparatus illustrated in FIG. 14 will be described. First, the component is loaded onto the jig J. Thereafter, the roller R of the apparatus may be moved along a guide portion G correspondingly to the fan-shaped surface of the component 30. Thereby, the decorative film F can be subjected to the transfer procedure to the fan-shaped surface of the component 30 by the roller R.

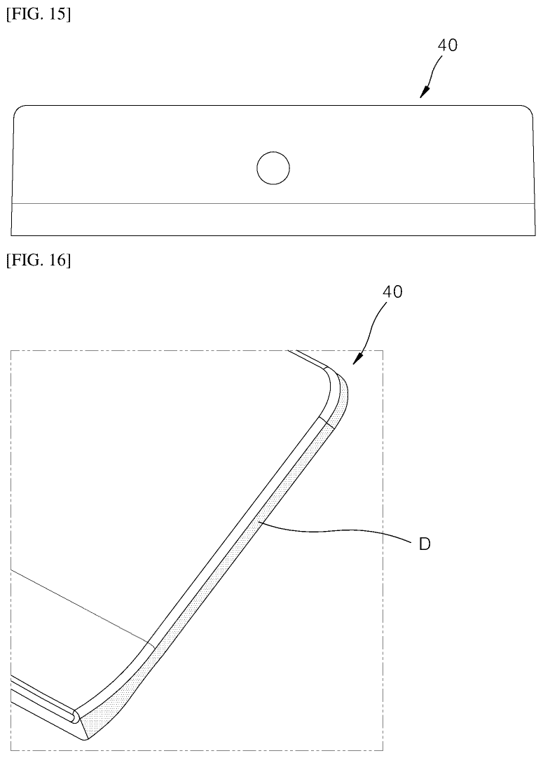

Next, FIG. 15 is a plan view illustrating a panel-shaped component 40 according to one embodiment of the present invention, and FIG. 16 is a perspective view illustrating a portion of the panel-shaped component 40 according to one embodiment of the present invention.

Referring to FIGS. 15 and 16, the component 40 according to one embodiment of the present invention may have a panel shape, and the decorative part formation region D may exist on at least a portion of the outer circumferential surface of the component. Preferably, the decorative part formation region D may be formed by subjecting the decorative film to the transfer procedure by the hot stamping process.

Here, the panel-shaped component refers to a component having a polyhedral shape, and is not necessarily limited to a hexahedral shape as in FIG. 15.

The panel-shaped component 40 may be applied to various home appliances, such as, for example, a washing machine and the like.

Here, the decorative part formed in the decorative part formation region D of the component 40 may be one which has formed continuously along the outer circumferential surface of the component 40, and the number of steps generated by the overlapping of the decorative part may be one or less.

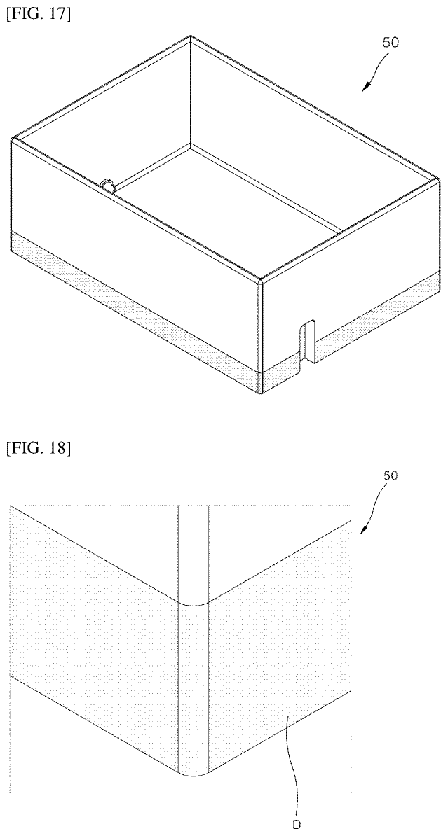

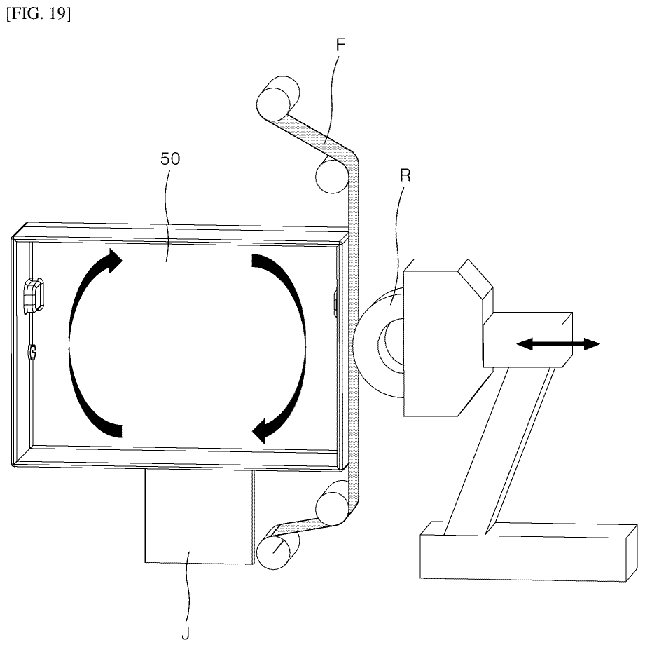

Next, FIG. 17 is a perspective view illustrating a basket-shaped component 50 according to one embodiment of the present invention, and FIG. 18 is a perspective view illustrating a portion of the basket-shaped component 50 according to one embodiment of the present invention.

Referring to FIGS. 17 and 18, the component 50 according to one embodiment of the present invention may have a basket shape, and the decorative part formation region D may exist on at least a portion of the outer circumferential surface of the component. Preferably, the decorative part formation region D may be formed by subjecting the decorative film to the transfer procedure by the hot stamping process.

Here, the basket-shaped component refers to a component with an empty internal space in which articles can be stored, and is not necessarily limited to a hexahedral shape as in FIG. 17.

The basket-shaped component 50 may be applied to various home appliances, such as, for example, refrigerators and the like.

Here, the decorative part formed in the decorative part formation region D of the component 50 may be one which has formed continuously along the outer circumferential surface of the component 50, and the number of steps generated by the overlapping of the decorative part may be one or less.

According to one example of the present invention, the decorative part may be formed on the outer circumferential surface of the basket-shaped component 50 using a hot stamping apparatus as shown in FIG. 19. Additionally, the decorative part may be formed on the surface of the panel-shaped component 40 using the apparatus illustrated in FIG. 19.

FIG. 19 shows a schematic view of the hot stamping apparatus forming the decorative part on the outer circumferential surface of the component 50.

The apparatus illustrated in FIG. 19 will be described. First, the component 50 is loaded onto the jig J. The component 50 may be rotated 360° by the jig J. The roller R of the apparatus is movable in the front and rear direction correspondingly to the shape of the component 50. Thereby, the decorative film F can be subjected to the transfer procedure to the outer circumferential surface of the component 50 by the roller R.

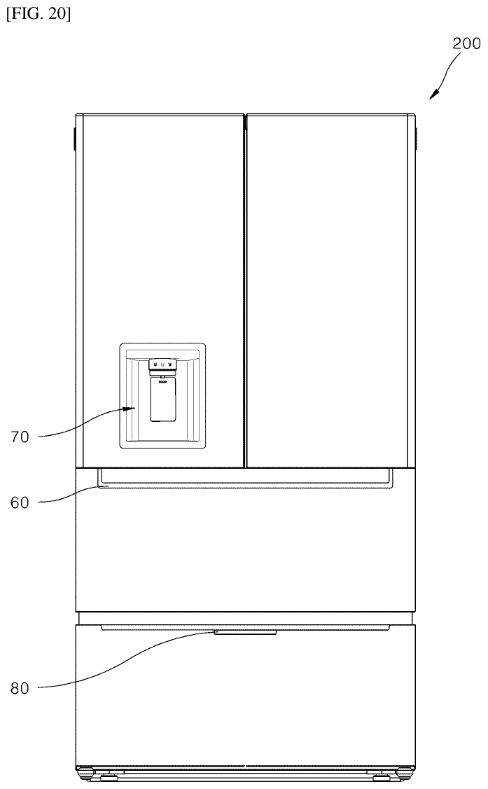

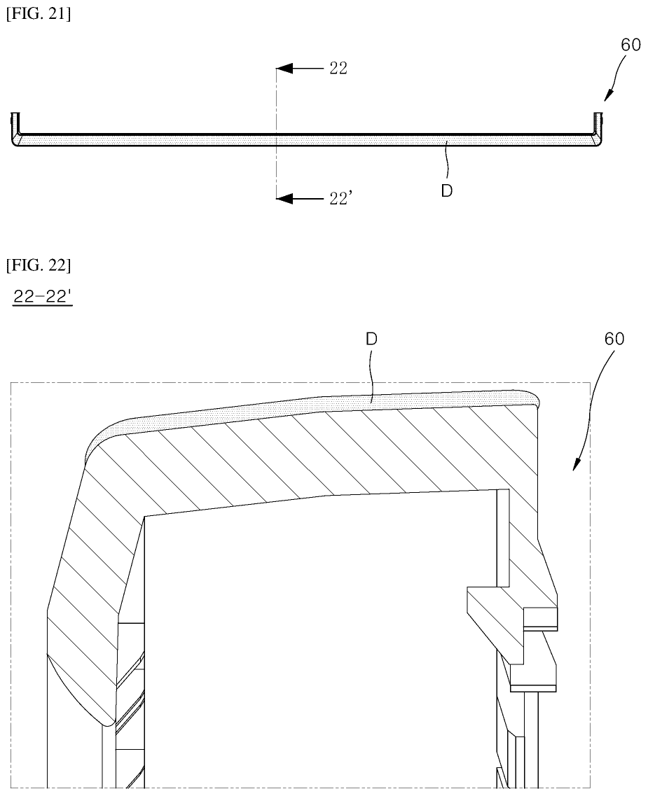

Next, FIG. 20 is a front view showing a refrigerator to which components of the present invention are applied. Referring to FIG. 20, the refrigerator 200 includes a handle component 60, a handle bar component 80, and a dispenser component 70, and the handle component 60, the handle bar component 80, and the dispenser component 70 all have the decorative part formation region D existing thereon.

FIG. 21 is a front view showing the handle component 60 according to one embodiment of the present invention, and FIG. 22 is a cross-sectional view taken along line 22-22′ in FIG. 21.

The handle component 60 is a component used to open the door provided in the refrigerator 200. Referring to FIGS. 21 and 22, the handle component 60 has a three-dimensional shape, and on at least a portion of its surface, there exists the decorative part formation region D in which the decorative part has been formed. Referring to the cross-sectional view illustrated in FIG. 22, the cross section of the portion of the handle component 60, on which the decorative part formation region D exists includes the bent portion in which the curvature varying section exists. Preferably, the decorative part formation region D may be formed by subjecting the decorative film to the transfer procedure by the hot stamping process.

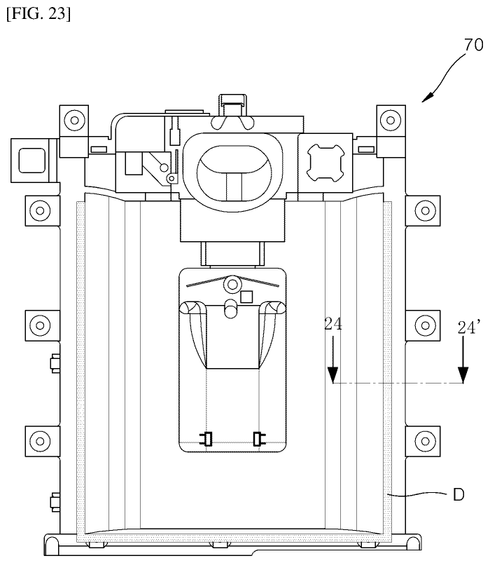

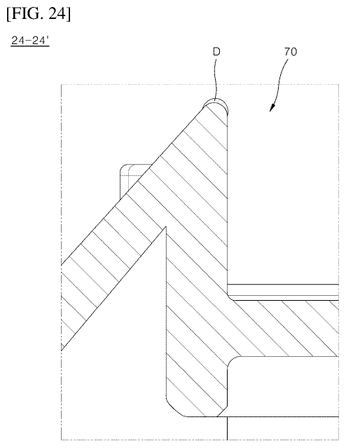

FIG. 23 is a front view illustrating the dispenser component 70 according to one embodiment of the present invention, and FIG. 24 is a cross-sectional view taken along line 24-24′ in FIG. 23.

The dispenser component 70 is a component used as a frame of a dispenser provided in the refrigerator 200. Referring to FIGS. 23 and 24, the dispenser component 70 has a three-dimensional shape, and on at least a portion of its surface, there exists the decorative part formation region D in which the decorative part has been formed. Referring to the cross-sectional view illustrated in FIG. 24, the cross section of the portion of the dispenser component 70, on which the decorative part formation region D exists includes the bent portion in which the curvature varying section exists. Preferably, the decorative part formation region D may be formed by subjecting the decorative film to the transfer procedure by the hot stamping process.

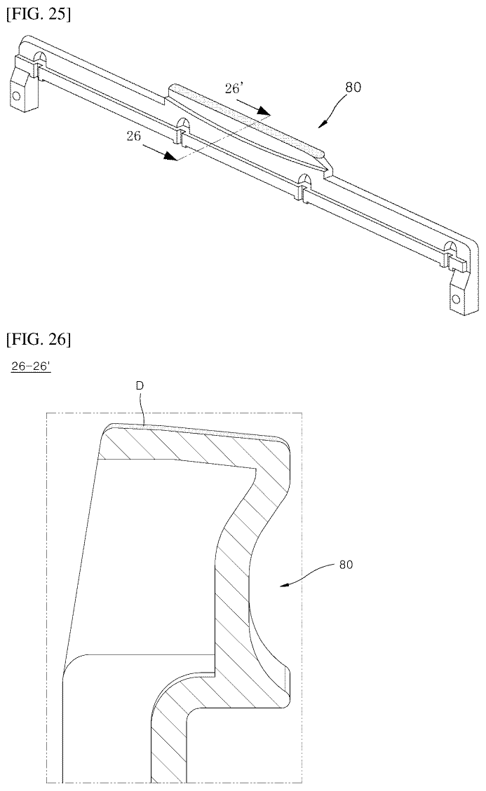

FIG. 25 is a front view showing the handle bar component 80 according to one embodiment of the present invention, and FIG. 26 is a cross-sectional view taken along line 26-26′ in FIG. 25.

The handle bar component 80 is a component used to open the door provided in the refrigerator 200. Referring to FIGS. 25 and 26, the handle bar component 80 has a three-dimensional shape, and on at least a portion of its surface, there exists the decorative part formation region D in which the decorative part has been formed. Referring to the cross-sectional view illustrated in FIG. 26, the cross section of the portion of the handle bar component 80, on which the decorative part formation region D exists includes the bent portion in which the curvature varying section exists. Preferably, the decorative part formation region D may be formed by subjecting the decorative film to the transfer procedure by the hot stamping process.

Although the present invention has been described with reference to the illustrative drawings as the above, the present invention is not limited to the embodiments and drawings disclosed in this specification, and it is obvious that various modifications can be made by those skilled in the art without departing from the scope of the technical idea of the present invention. Additionally, even if the effects related to the configuration of the present invention were not explicitly described while explaining the embodiments of the present invention, it is obvious that the effects predictable from the configuration should also be acknowledged.

What is claimed is:

1. A component for home appliances having a three-dimensional shape, the component comprising:
a decorative part formation region in which a decorative part has been formed and which exists on at least a portion of a surface of the component,
wherein a cross section of the decorative part formation region includes a bent portion in which a curvature varying section exists.

2. The component for home appliances of claim 1, wherein the curvature varying section includes an overlapping section of lines with different curvatures or an inflection point where lines with different curvatures meet with each other.

3. The component for home appliances of claim 1, wherein in the decorative part formation region, the decorative part has been formed continuously.

4. The component for home appliances of claim 1, wherein in the decorative part formation region, the decorative part is formed continuously, and a number of steps generated by an overlapping of the decorative part is one or less.

5. The component for home appliances of claim 1, wherein the decorative part is formed by subjecting a decorative film to a transfer procedure by a hot stamping process.

6. The component for home appliances of claim 1, wherein the component includes an edge having an asymmetrical shape,
wherein a cross section of the edge includes a bent portion in which a curvature varying section exists, and
wherein on at least a portion of a surface of the edge, the decorative part formation region exists.

7. The component for home appliances of claim 1, wherein the component has a cylindrical shape,
wherein a chamfer is formed at a corner portion where an upper surface and an outer circumferential surface of the component meet with each other, and
wherein on at least a portion of a surface of the chamfer, the decorative part formation region exists.

8. The component for home appliances of claim 1, wherein the component has a fan-shaped surface, and
wherein on at least a portion of the fan-shaped surface, the decorative part formation region exists.

9. The component for home appliances of claim 1, wherein the component has a panel shape, and
wherein on at least a portion of an outer circumferential surface of the component, the decorative part formation region exists.

10. The component for home appliances of claim 1, wherein the component has a basket shape, and
wherein on at least a portion of an outer circumferential surface of the component, the decorative part formation region exists.

11. The component for home appliances of claim 9, wherein the decorative part is formed continuously along the outer circumferential surface, and
wherein a number of steps generated by an overlapping of the decorative part is one or less.
